(19) United States
(12) Patent Application Publication
(10) Pub. No.: US 2015/0332334 A1
(43) Pub. Date: Nov. 19, 2015

(54) PERSONALIZED GROUP COUPONS AND OFFERS WITH USER EXPERIENCE

(71) Applicant: MICROSOFT CORPORATION, Redmond, WA (US)

(72) Inventors: Hadas Bitran, Ramat Hasharon (IL); Shira Weinberg, Tel Aviv (IL); Amos Haggiag, Tel Aviv (IL); Elinor Axelrod, Hod Hasharon (IL)

(73) Assignee: MICROSOFT CORPORATION, Redmond, WA (US)

(21) Appl. No.: 14/276,417

(22) Filed: May 13, 2014

(51) Int. Cl. G06Q 30/02

(52) U.S. Cl. CPC G06Q 30/0269; G06Q 30/0261; G06Q 50/01

(57) ABSTRACT

A user experience (UX) that enables viewing and identification of other people in the user network of friends, that received a group coupon, and the participation status of the friends. The UX enables the user to chat with the people in the user's network of friends about a specific coupon that was received, enables the creation of a group of friends and the adding of another friend with high density friendship of shared common interests and/or location based on specific offer content, enables granularity on a sub-group of friends based on joint interests, the controlled exposure to the user that received the group coupon offer, the identity of other users in his group that got this coupon offer, controlled exposure to the user that received the group coupon offer, the identity of other users in his group that committed to buy the coupon, and if the group will redeem the coupon.

### BACKGROUND

Existing group coupon models relate to the use of coupons that become valid only if a group of people committing to buy reached a pre-defined size; however, the users have no idea who the other people are and how many people were offered the coupon. Additional shortcomings include: the group coupons are not targeted at a group of friends, but people who are typically complete strangers to one another; the existing group coupon is not based on a joint realtime location of a group of users (e.g., receive offers within the shopping center the user is currently located); the user does not know who else received the coupon; and, there is no way for the user to coordinate between the people that were offered the coupon, and initiate consultation among them.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture enables a user experience (UX) for a user to view and identify the other people in the user network of friends, that received a group coupon, and the participation status (e.g., purchased, declined, not yet decided to participate, etc.) of the friends. The UX also enables the user to chat with the people in the user's network of friends about a specific coupon that was received. The UX can be employed in combination with a social network, such as a Facebook™ application that displays coupons, the list of friends, enables chat, and so on.

The architecture also enables the creation of a group of friends with “high density” (of a graph) friendship of shared common interests and/or location based on specific offer content. A mechanism is provided that enables granularity on a sub-group of friends based on joint interests, the managed exposure (only users of the cluster can see the matched offer/coupon and not different offers/coupons of other users) to the user that received the group coupon offer, the identity of other users in his group that got this coupon offer, as well as managed exposure to the user that received the group coupon offer, the identity of other users in his group that committed to buy the coupon, and if the group will redeem the coupon.

In other words, the user can see the identities of the other people that received a specific offer/coupon. The user can get multiple offers/coupons, each aimed at a different group of friends in which the user is currently included. For example, a user may receive a coupon targeted at the parents of the school the user's child attends and a different coupon aimed at the friends of the user who participate in an exercise activity (e.g., spinning) However, the user cannot see all the offers/coupons that another user has received. Continuing with the previous example, the friends of the user's exercise activity can see that the user received the same coupon the friends received, but the friends cannot see the coupon the user received as a school parent.

The architecture also enables users to chat about the coupon within the group of people that received the coupon offer (e.g., convince each other to participate in the offer).

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system in accordance with the disclosed architecture.

FIG. 2 illustrates an alternative system in accordance with the disclosed architecture.

FIG. 3 illustrates a user interface for a coupon deals page of a user device that presents a list of available coupons/offers.

FIG. 4 illustrates a user interface that presents a coupon details page.

FIG. 5 illustrates a user interface that presents a friends page.

FIG. 6 illustrates a user interface that presents a chat page.

FIG. 7 illustrates a method in accordance with the disclosed architecture.

FIG. 8 illustrates an alternative method in accordance with the disclosed architecture.

FIG. 9 illustrates a block diagram of a computing system that executes personalized group offers and coupons in accordance with the disclosed architecture.

### DETAILED DESCRIPTION

The disclosed architecture enables a user experience (UX) for a user to view and identify the other people in the user network of friends, that received a group coupon, and the participation status (e.g., purchased, declined, not yet decided to participate, etc.) of the friends. The UX also enables the user to chat with the people in the user's network of friends about a specific coupon that was received by all of them. The architecture also enables the creation of a group of friends with high density friendship of shared common interests and/or location based on specific offer content. Creation refers to both implicit and explicit group creation. Implicit group creation means that the system understands the interests and the relationships and creates logical clusters of people based on that understanding, while explicit group creation means that people are grouped into the group beforehand, such as members of a closed social network group representing all the parents of a certain school, for example.

A mechanism is provided that enables granularity on a subgroup of friends based on joint interests, the controlled exposure to the user that received the group coupon offer, the identity of other users in his group that got this coupon offer, as well as controlled exposure to the user that received the group coupon offer, the identity of other users in his group that committed to buy the coupon, and if the group will redeem the coupon. The architecture also enables users to chat about the coupon within the group of people that received the coupon offer (e.g., convince each other to participate in the offer).

The architecture also enables the offer of group coupons to users based on friendship with one another (private case: push group coupons to a group of friends where everyone is friends with everyone), the offer of group coupons to users based on physical proximity to one another that are in a nearby location, and to provide friends the group offers that relate to realtime location and time bound within a physical area (e.g., a shopping center).

A user interface (UI) is provided via which a user can browse group coupons offered to the user. The UI enables a user to view what other users in the user's network of friends, received the group coupon (offer) and the status of the friends, such as purchased, declined, or undecided, or similar notions. A UI element can be provided to show a coupon (offer) threshold for a minimum number of users of the group that need to participate, and how many more users need to indicate participation in order to make the group coupon valid (redeemable). The UI also enables user chat, with the other users in the user network of friends that received the group coupon, about a different specific coupon to convince users to join (participate) and schedule calendar meetings for joint usage of the coupon.

An extension of this is the offer may be exclusive to the group, meaning that the group members cannot add another person; or non-exclusive, meaning that the offer allows a user to add another friend to the offer. If another friend is added to the offer by a certain user, everyone else who received the offer can see this additional friend. The UI can then be designed to enable the addition of another friend.

The architecture also enables periodic ingestion of available coupons/offers from the merchants/advertisers according to push and/or pull schemes. For example, an offers management service can pull (request) the offers/coupons from merchants/advertisers on a frequent basis (e.g., once-a-day) whether offers are available or not, the merchants/advertisers can push the offers/coupons to the management service asynchronously or at predefined times, and so on.

The architecture also enables the capability for the advertisers/merchants to define target audiences and different coupon parameters (e.g., size of group, quota, etc.). A clustering engine identifies clusters of targetable groups of friends according to corresponding joint interests, location proximity per coupon content (also supported in realtime), etc. The clustering engine enables the selection of friend-group coupons and offers that best match a cluster.

The architecture may also include a component/auction mechanism that enables advertisers/merchants to compete between themselves on a certain identified group or cluster of people. For example, if there is a limit to the number of coupons to be presented to a group in order not to flood the group with offers, advertisers may be competing on the privilege to present an offer to the group using an auction mechanism.

Client device capability is provided for displaying currently offered coupons, for displaying to the device user the identities of friends in the group that received the coupon, including the ability to privately chat about the coupon within that group of friends and the identities of the friends that committed to participating. The group services component comprises a realtime notification engine to notify group members if the coupon is eligible to be redeemed, as well as other information.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

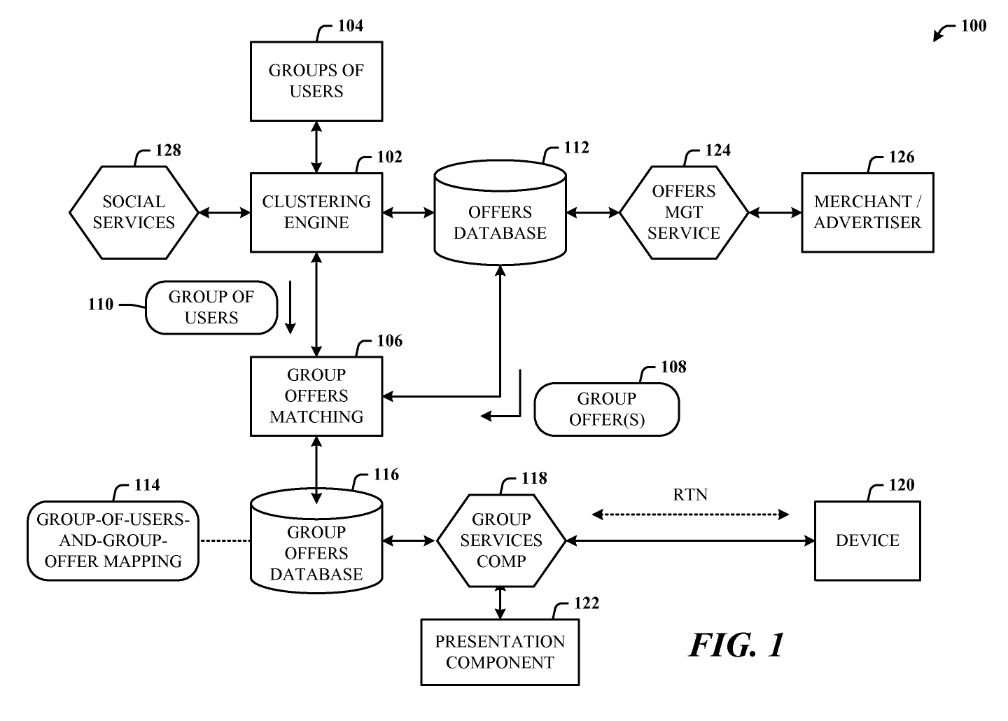

FIG. 1 illustrates a system 100 in accordance with the disclosed architecture. The system 100 can include a clustering engine 102 configured to identify and create groups of users 104, each cluster of users grouped according to a related interest. A group offers matching component 106 matches one or more group offers 108 to a group of users 110 of the groups of users 104, the group of users 110 having a related (or common) interest. The one or more group offers 108 are derived by the group offers component 106, as accessed from an offers database 112. A group-of-users-and-group-offer mapping 114, as derived by the group offers matching component 106, is stored in a group offers database 116.

A group services component 118 (or offers service) is configured to communicate the group offer(s) 108 to a device 120 of a user of the group of users 110. Each user of the group of users 110 receives notification of the offer(s) 108. This can be a realtime notification (RTN) to each of the group users (user devices). The group services component 118 is associated with a presentation component 122 configured to display the group offer(s) 108 to the group of users 110. The presentation component 122 can enable presentation of the offer(s) 108 via a browser application of the device 120.

The clustering engine 102 can create a subgroup in the group of users 110, where the subgroup has a different interest than the related interest of the group of users 110. For example, if five of the group users are clustered based on an interest in a given restaurant general offering of (“20% off all orders at Restaurant B”), a subgroup of three of the five group users can be created based on an interest not for the general offer, but for a specific offering of Restaurant B, such as sushi.

The system 100 can further comprise an offers management service 124 that receives offers from a merchant/advertiser 126 and stores the offers in the offers database 112. The received offers from the merchant/advertiser 126 can grouped by the offers matching component 106. The offers management service 124 can send the received offers directly to the clustering engine 102 to be clustered as well.

The group services component 118 communicates to the group of users 110, the identities of other users of the group that received the group offer(s) 108 and participation status of the other users to the group offer(s) 108. The group services component 118 communicates to a group user (device 120) the identities of other users of the group that are participating in the offer(s) 108 and a minimum number of user needed to participate and redeem the group offer(s) 108.

The group services component 118 communicates to a group user (device 120 thereof) the identities of other users of the group that committed to purchase a group coupon for the group offer. The group services component 118 communicates participation status of other group users who received the group offer(s) 108 and enables chat communications between the group users to discuss the group offer(s) 108. It can be the case that the group user who is undecided can be given a fixed time period (maximum time) in which to respond; otherwise, that user is removed from the threshold or simply automatically changed to a non-participating user (declined). The group services component 118 also enables the capability of adding more friends to the offer/coupon or group.

The clustering engine 102 can interface to social services 128 such as services that enable access to social networks to obtain “friends” information, for example. In general, the social services 128 enable access to information that defines user connections to each other that then may be used to describe a user-to-user relationship and common interests. The interests information can be obtained from user profiles, derived from historical user activities, location information, communications information (e.g., chat, messages, posts, emails, etc.), and so on. Social networks provide many different ways for user to connect such as via user interactive buttons, as well as from computer-prompted request for connections. Algorithms can be run on graphs to find people who know each other and who have common interests.

It is within contemplation of the disclosed architecture that a user who may not have been originally targeted (clustered) by the computing system as a member of the group and who would receive the offer/coupon, can be “brought in” to the group by one of the current group users since the group user may have knowledge of this outside user that the system lacked. The additional person can be “brought in” for a specific coupon after a coupon is offered, and not necessarily to an explicit group. Additionally, the grouping may or may not be transparent to the users that are in it (as relates to the implicit/explicit membership described above).

Thus, manual user interaction to bring this user into the group offer provides feedback to the architecture for use in future clustering. Once the user is brought into the group, the architecture will then apply all the features normally applied to an original group user, such as chat, friend interaction, realtime notifications, etc. It can also be the case that when attempting to bring a user into the group, a voting system is employed by the original group users to vote on allowing the user in.

User relationships can be determined or connected by any social means, such as “friending” in Facebook™, “following” in Twitter™, etc., and/or member of a group in a social network such as a Facebook group, Meetup group, etc. It is also to be understood that friendship can be defined based on a user relationship (e.g., interaction in some way) with the rest of the users, for example, they frequently call each other, text each other, email each other, etc. For example, a relationship can be defined or restricted to a bi-directional connection where a first user needs to manually connect to a second user and the second user must connect back to the first user, in order for the relationship to be valid. Alternatively, it can also be the more relaxed case where the relationship need only be unidirectional such that only one of the two users needs to establish the connection for the two users to be considered related.

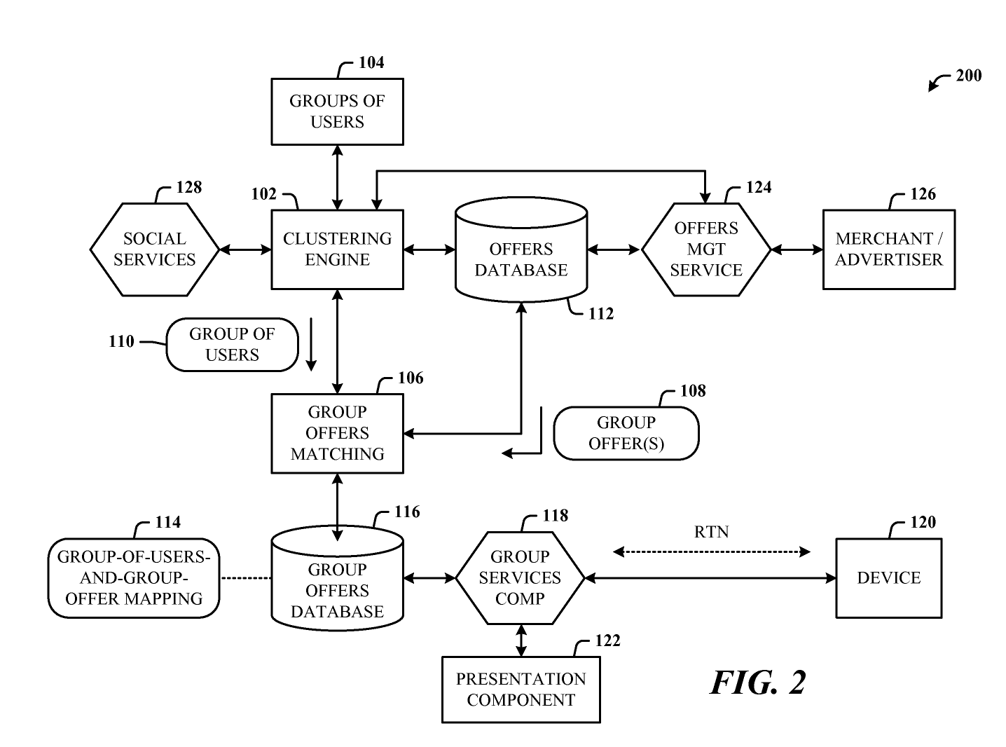

FIG. 2 illustrates an alternative system 200 in accordance with the disclosed architecture. In system 200, the offers management service 124 can interface directly to the clustering engine 102. The clusters derived from the clustering engine 102 can be shipped back to the offers management service 124 for exposure to the merchant/advertiser 126. The auction/competition for the right to offer a coupon to the group may occur here. The merchant/advertiser 126 can then see the where content/offers/coupons can be pushed. On a regular basis (e.g., nightly) the clustering engine 102 can update the offers management service 124 with interesting clusters that can be accessed. When the merchant/advertiser 126 accesses the cluster information indicating a common interest, the merchant/advertiser 126 can then pick which clusters to engage and create new and/or apply existing campaigns to these clusters.

With respect to both systems (100 and 200), the following descriptions can apply. A user interface (UI) is provided via which a user can browse group coupons offered to the user. The UI enables a user to view what other users in the user's network of friends, received the group coupon (offer) and the status of the friends, such as purchased, declined, or undecided, or similar notions. A UI element can be provided to show a coupon (offer) threshold for a minimum number of users of the group that need to participate, and how many more users need to indicate participation in order to make the group coupon valid (redeemable). The UI also enables user chat, with the other users in the user network of friends that received the group coupon, about a different specific coupon to convince users to join (participate) and schedule calendar meetings for joint usage of the coupon.

The systems (100 and 200) also enable periodic ingestion of available coupons/offers from the merchants/advertisers according to push and/or pull schemes. For example, the offers management service 124 can pull (request) the offers/coupons from the merchants/advertisers 126 on a frequent basis (e.g., once-a-day) whether offers are available or not, the merchants/advertisers 126 can push the offers/coupons to the management service 124 asynchronously or at predefined times, and so on.

It can be the case that the offers management service 124 presents a display template to the merchant/advertiser that when completed and the associated content is uploaded enables the services 124 to more efficiently ingest the coupon/offer campaign into the architecture. The template (user interface) can request definition of the target parameters such as interests, demographics, time duration of the offer, offer merchant, offer details, etc. The capability of the merchant/advertiser 126 to define the group characteristics enables more effective clustering results: only a certain age group, a close group of friends, they must all know each other or 80% know each other, and they all (or 90%) need to be interested in a certain interest (e.g., biking) Hence, in this case where the merchant/advertiser 126 defines the characteristics (criteria) of the closed group, which characteristics can then enable direct input to the clustering engine 102, for example.

The systems (100 and 200) also enable the capability for the advertisers/merchants 126 to define target audiences and different coupon parameters (e.g., size of group, quota, etc.). The clustering engine 120 identifies clusters of targetable groups of friends according to corresponding joint interests, location proximity per coupon content (also supported in realtime), etc. The clustering engine 102 enables the selection of friend-group coupons and offers that “best” match a cluster, where the best match can be in terms of best deal (e.g., the biggest discount), most suitable to the group and/or just the offer that won the bid for this audience in an auction (e.g., when the system proactively identifies a cluster and then offers it to the advertisers to compete).

Client device capability is provided for displaying currently offered coupons, for displaying to the device user the identities of friends in the group that received the coupon, including the ability to privately chat about the coupon within that group of friends and the identities of the friends that committed to participating. The group services component 118 comprises a realtime notification engine to notify group members if the coupon is eligible to be redeemed, as well as other information.

It is to be understood that in the disclosed architecture, certain components may be rearranged, combined, omitted, and additional components may be included. Additionally, in some embodiments, all or some of the components are present on the client, while in other embodiments some components may reside on a server or are provided by a local or remove service.

Although not shown, a privacy component can be enabled for authorized and secure handling of user information. The privacy component can enable the user to opt-in and opt-out of providing either intentionally or unintentionally, personal information that may have been obtained at and utilized thereafter. The user can be provided with notice of the collection of personal information, for example, and the opportunity to provide or deny consent to do so. The consent can include opting in to the whole group coupon experience; however, it may be more granular such as for certain groups or certain friends, for example.

Following is a description of exemplary user experiences that can be provided for personalized group offers with user experience.

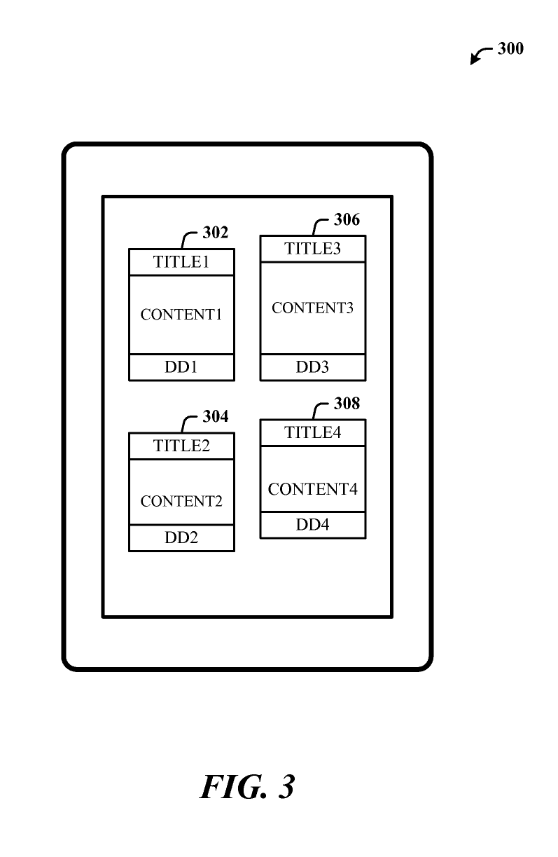

FIG. 3 illustrates a user interface for a coupon deals page 300 of a user device that presents a list of available coupons/offers. Here, the UI 300 can be scrollable to enable the viewing of part of a group of interactive coupons/offers within the confines of the device display: a first offer/coupon 302 having a title (TITLE1), associated content (CONTENT1) (e.g., text, image, audio, video), and deal data (DD1) that defines the offer; a second offer/coupon 304 having a title (TITLE2), associated content (CONTENT2), and deal data (DD2) that defines the offer; a third offer/coupon 306 having a title (TITLE3), associated content (CONTENT3), and deal data (DD3) that defines the offer; and, a fourth offer/coupon 308 having a title (TITLE4), associated content (CONTENT4), and deal data (DD4) that defines the offer.

When the user selects one of the offer/coupons (e.g., the first offer/coupon 302), the user is routed to all other users in the same group that are being prompted for participation. Thus, while the user of the device presenting the UI 300 views some set of different offers/coupons, each selection may route the user to different groups of users.

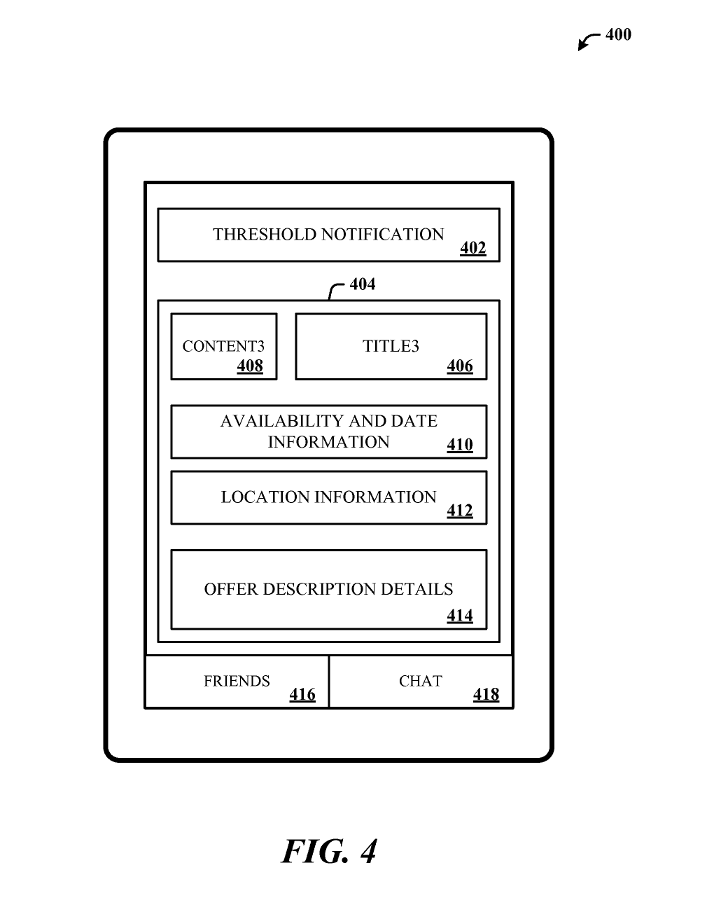

Other offers/coupons can be presented but may be out of view and require user interaction (scrolling) for viewing. After the user selects a coupon, the user is able to see a coupon details page and additional options at the bottom of the page as shown in FIG. 4.

FIG. 4 illustrates a user interface that presents a coupon details page 400. The details page 400 can include a threshold notification section 402 that indicates the number of remaining users needed to obtain the detail (e.g., “3 more joiners to go!”) and an offer details section 404. The offer details section 404 can further comprise the title 406 and image content 408 of the selected coupon, availability (e.g., “1 of 1 coupon available”) information and date information 410 (e.g., expiration data “expires 4/28/xxxx”), location information 412 (e.g., address of merchant location and distance to merchant location), and offer description details 414 (e.g., expiration date (e.g., “expires 4/28/xxx”), and restrictions such as “limit one per table”, “reservation required”, “valid only between <dates>”, “not valid with other offers”, “tax and gratuity not included”, etc.

The details page 400 can also include interactive objects for “Friends” 414 and “Chat” 418. The Friends 414 option shows all the user's friends that received the coupon and have the purchase option. The user can also view which of the user's friends already purchased the coupon, who rejected it, and who has not yet decided. The user can also view what the threshold is and how many more people need to purchase the coupon in order to make the group offer valid (the threshold notification 402).

The Chat 418 option enables the user to chat with users in the group of friends that have been offered the coupon. For example, chat enables the discussion of what would be the best place for the user to convince friends to purchase the coupon and decide to go to the restaurant together, after all the friends purchase the coupon. The user is also able to schedule a calendar meeting with all the friends that purchased the coupon, directly from this view, for joint usage of the coupon.

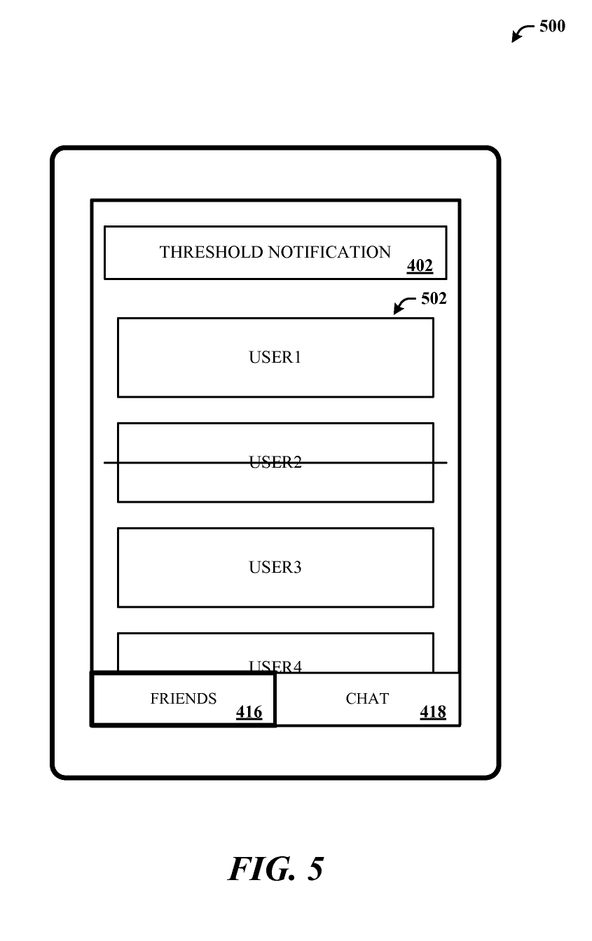

FIG. 5 illustrates a user interface that presents a friends page 500. When interacting to select (e.g., clicking) the “Friends” 416 option, the user is presented with the threshold notification 402 and a list 502 of friends who have joined (participated in the offer), and those friends who are still pending (undecided). The list can be presented in alphabetical order in the top-down manner.

In the specific UX shown, graphical emphasis (e.g., coloration, bolding, fonts, strike-through, etc.) can be applied to the list items (of friends) to indicate (e.g., a green color) friends who have already joined and purchased the coupon, and indicate (e.g., a red color) the friends who are still pending (undecided). Graphical emphasis (e.g., a strike-through as for USER2) can also be applied to friends that rejected the offer. A user may also add (e.g., assign, link or connect) a friend to a specific coupon.

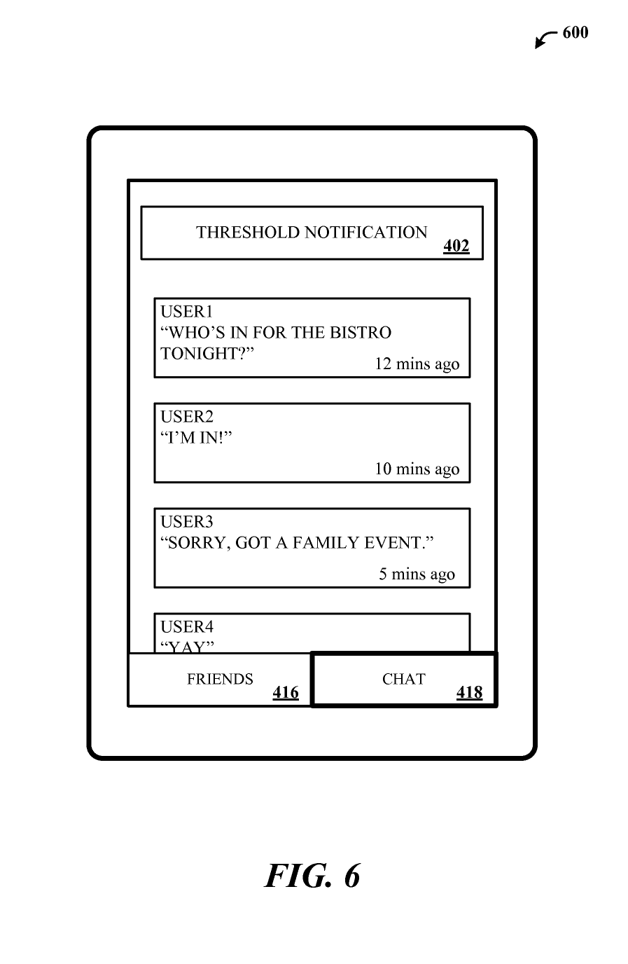

FIG. 6 illustrates a user interface that presents a chat page 600. When the user (USER1) interacts to select (e.g., clicking) the “Chat” 418 option, the user is then provided the capability to chat with the group of friends (e.g., USER2, USER3, etc.) for any desired purposes, such as to convince everyone to join, and in this specific case, schedule a time for meeting at the restaurant to use the coupon(s).

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

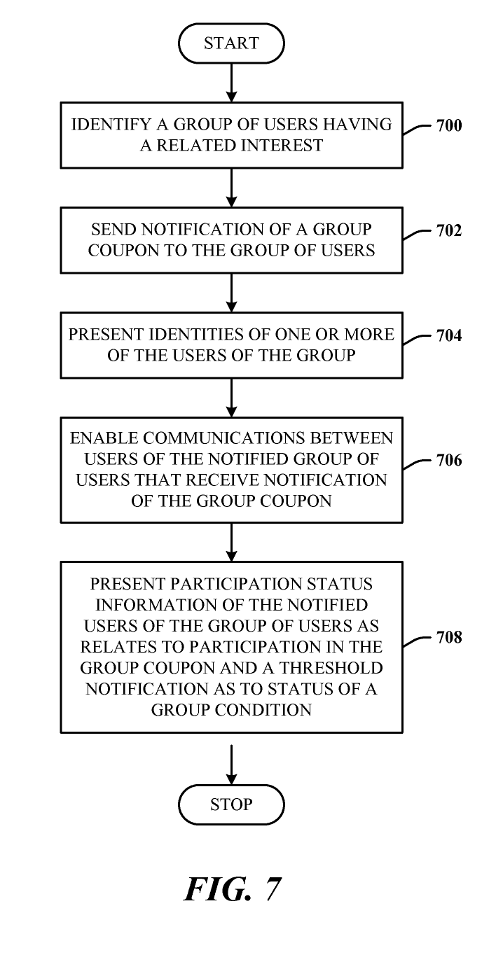

FIG. 7 illustrates a method in accordance with the disclosed architecture. At 700, a group of users having a related interest is identified. At 702, notification of a group coupon is sent to the group of users. The matching of the coupon to the group can be accomplished according to joint interests and location proximity, for example. At 704, identities of one or more of the users of the group are presented. At 706, communications is enabled between users of the notified group of users that receive notification of the group coupon. At 708, participation status information of the notified users of the group of users is presented as relates to participation in the group coupon and a threshold notification as to status of a group condition (e.g., “three more joiners to go”).

The method can further comprise presenting the participation status as relates to participating, undecided, and non-participating. The method can further comprise enabling chat communications between users about a specific coupon.

The method can further comprise creating the group of users from networks of socially-related users. The method can further comprise creating a sub-group from the group, the sub-group of users having related interests. The method can further comprise matching offers to the group of users as viewable coupons.

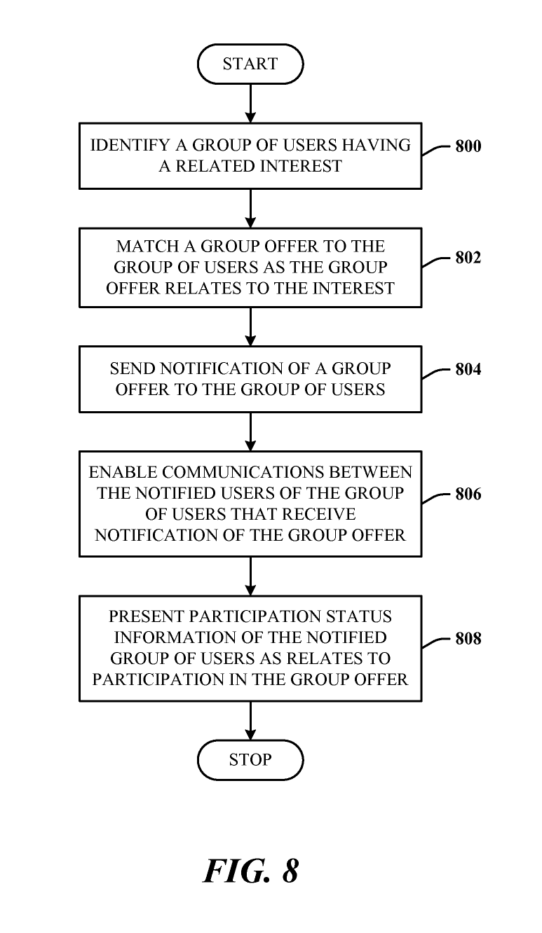

FIG. 8 illustrates an alternative method in accordance with the disclosed architecture. The method can be embodied as a computer-readable storage medium comprising computer-executable instructions that when executed by a microprocessor, cause the microprocessor to perform the method.

At 800, a group of users having a related interest is identified. At 802, a group offer is matched to the group of users as the group offer relates to the interest. At 804, notification of a group offer is sent to the group of users. At 806, communications is enabled between the notified users of the group of users that receive notification of the group offer. At 808, participation status information of the users of the notified group of users is presented as relates to participation in the group offer.

The method can further comprise scheduling joint usage of the group offer. The capability can be enabled via the UI to offer the friends an additional capability to chat among themselves after the coupon has reached its target and has been purchased by them all for the sake of coordinating the usage. The method can further comprise identifying clusters of targetable groups of friends according to joint interest and location proximity relative to the group offer location.

The method can further comprise enabling realtime notification to group users related to eligibility of the offer to be redeemed. The method can further comprise offering for bid to vendors a specific group of users and receiving from a winning vendor targeted user information and offer parameters from which to identify the group of users and apply the parameters.

As used in this application, the terms “component” and “system” are intended to refer to a computer-related entity, either hardware, a combination of software and tangible hardware, software, or software in execution. For example, a component can be, but is not limited to, tangible components such as a microprocessor, chip memory, mass storage devices (e.g., optical drives, solid state drives, and/or magnetic storage media drives), and computers, and software components such as a process running on a microprocessor, an object, an executable, a data structure (stored in a volatile or a non-volatile storage medium), a module, a thread of execution, and/or a program.

By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

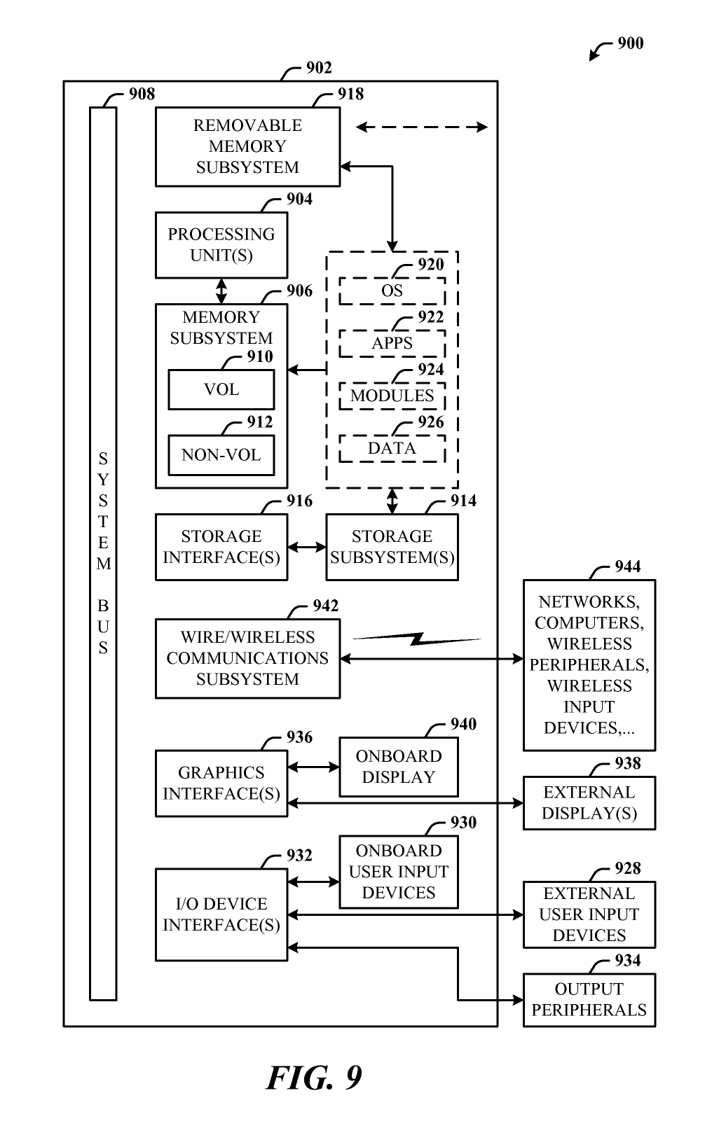

Referring now to FIG. 9, there is illustrated a block diagram of a computing system 900 that executes personalized group offers and coupons in accordance with the disclosed architecture. However, it is appreciated that the some or all aspects of the disclosed methods and/or systems can be implemented as a system-on-a-chip, where analog, digital, mixed signals, and other functions are fabricated on a single chip substrate.

In order to provide additional context for various aspects thereof, FIG. 9 and the following description are intended to provide a brief, general description of the suitable computing system 900 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 900 for implementing various aspects includes the computer 902 having microprocessing unit(s) 904 (also referred to as microprocessor(s) and processor(s)), a computer-readable storage medium such as a system memory 906 (computer readable storage medium/media also include magnetic disks, optical disks, solid state drives, external memory systems, and flash memory drives), and a system bus 908. The microprocessing unit(s) 904 can be any of various commercially available microprocessors such as single-processor, multi-processor, single-core units and multi-core units of processing and/or storage circuits. Moreover, those skilled in the art will appreciate that the novel system and methods can be practiced with other computer system configurations, including minicomputers, mainframe computers, as well as personal computers (e.g., desktop, laptop, tablet PC, etc.), hand-held computing devices, microprocessor-based or programmable consumer electronics, and the like, each of which can be operatively coupled to one or more associated devices.

The computer 902 can be one of several computers employed in a datacenter and/or computing resources (hardware and/or software) in support of cloud computing services for portable and/or mobile computing systems such as wireless communications devices, cellular telephones, and other mobile-capable devices. Cloud computing services, include, but are not limited to, infrastructure as a service, platform as a service, software as a service, storage as a service, desktop as a service, data as a service, security as a service, and APIs (application program interfaces) as a service, for example.

The system memory 906 can include computer-readable storage (physical storage) medium such as a volatile (VOL) memory 910 (e.g., random access memory (RAM)) and a non-volatile memory (NON-VOL) 912 (e.g., ROM, EPROM, EEPROM, etc.). A basic input/output system (BIOS) can be stored in the non-volatile memory 912, and includes the basic routines that facilitate the communication of data and signals between components within the computer 902, such as during startup. The volatile memory 910 can also include a high-speed RAM such as static RAM for caching data.

The system bus 908 provides an interface for system components including, but not limited to, the system memory 906 to the microprocessing unit(s) 904. The system bus 908 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 902 further includes machine readable storage subsystem(s) 914 and storage interface(s) 916 for interfacing the storage subsystem(s) 914 to the system bus 908 and other desired computer components and circuits. The storage subsystem(s) 914 (physical storage media) can include one or more of a hard disk drive (HDD), a magnetic floppy disk drive (FDD), solid state drive (SSD), flash drives, and/or optical disk storage drive (e.g., a CD-ROM drive DVD drive), for example. The storage interface(s) 916 can include interface technologies such as EIDE, ATA, SATA, and IEEE 1394, for example.

One or more programs and data can be stored in the memory subsystem 906, a machine readable and removable memory subsystem 918 (e.g., flash drive form factor technology), and/or the storage subsystem(s) 914 (e.g., optical, magnetic, solid state), including an operating system 920, one or more application programs 922, other program modules 924, and program data 926.

The operating system 920, one or more application programs 922, other program modules 924, and/or program data 926 can include items and components of the system 100 of FIG. 1, items and components of the system 200 of FIG. 2, items and components of the pages of FIGS. 3-6, and the methods represented by the flowcharts of FIGS. 7 and 8, for example.

Generally, programs include routines, methods, data structures, other software components, etc., that perform particular tasks, functions, or implement particular abstract data types. All or portions of the operating system 920, applications 922, modules 924, and/or data 926 can also be cached in memory such as the volatile memory 910 and/or non-volatile memory, for example. It is to be appreciated that the disclosed architecture can be implemented with various commercially available operating systems or combinations of operating systems (e.g., as virtual machines).

The storage subsystem(s) 914 and memory subsystems (906 and 918) serve as computer readable media for volatile and non-volatile storage of data, data structures, computer-executable instructions, and so on. Such instructions, when executed by a computer or other machine, can cause the computer or other machine to perform one or more acts of a method. Computer-executable instructions comprise, for example, instructions and data which cause a general purpose computer, special purpose computer, or special purpose microprocessor device(s) to perform a certain function or group of functions. The computer executable instructions may be, for example, binaries, intermediate format instructions such as assembly language, or even source code. The instructions to perform the acts can be stored on one medium, or could be stored across multiple media, so that the instructions appear collectively on the one or more computer-readable storage medium/media, regardless of whether all of the instructions are on the same media.

Computer readable storage media (medium) exclude (excludes) propagated signals per se, can be accessed by the computer 902, and include volatile and non-volatile internal and/or external media that is removable and/or non-removable. For the computer 902, the various types of storage media accommodate the storage of data in any suitable digital format. It should be appreciated by those skilled in the art that other types of computer readable medium can be employed such as zip drives, solid state drives, magnetic tape, flash memory cards, flash drives, cartridges, and the like, for storing computer executable instructions for performing the novel methods (acts) of the disclosed architecture.

A user can interact with the computer 902, programs, and data using external user input devices 928 such as a keyboard and a mouse, as well as by voice commands facilitated by speech recognition. Other external user input devices 928 can include a microphone, an IR (infrared) remote control, a joystick, a game pad, camera recognition systems, a stylus pen, touch screen, gesture systems (e.g., eye movement, body poses such as relate to hand(s), finger(s), arm(s), head, etc.), and the like. The user can interact with the computer 902, programs, and data using onboard user input devices 930 such a touchpad, microphone, keyboard, etc., where the computer 902 is a portable computer, for example.

These and other input devices are connected to the microprocessing unit(s) 904 through input/output (I/O) device interface(s) 932 via the system bus 908, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 932 also facilitate the use of output peripherals 934 such as printers, audio devices, camera devices, and so on, such as a sound card and/or onboard audio processing capability.

One or more graphics interface(s) 936 (also commonly referred to as a graphics processing unit (GPU)) provide graphics and video signals between the computer 902 and external display(s) 938 (e.g., LCD, plasma) and/or onboard displays 940 (e.g., for portable computer). The graphics interface(s) 936 can also be manufactured as part of the computer system board.

The computer 902 can operate in a networked environment (e.g., IP-based) using logical connections via a wired/wireless communications subsystem 942 to one or more networks and/or other computers. The other computers can include workstations, servers, routers, personal computers, microprocessor-based entertainment appliances, peer devices or other common network nodes, and typically include many or all of the elements described relative to the computer 902. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 902 connects to the network via a wired/wireless communication subsystem 942 (e.g., a network interface adapter, onboard transceiver subsystem, etc.) to communicate with wired/wireless networks, wired/wireless printers, wired/wireless input devices 944, and so on. The computer 902 can include a modem or other means for establishing communications over the network. In a networked environment, programs and data relative to the computer 902 can be stored in the remote memory/storage device, as is associated with a distributed system. It will be appreciated that the network connections shown are exemplary and other means of establishing a communications link between the computers can be used.

The computer 902 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related technology and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a clustering engine configured to identify and create a group of users having a related interest;
an offers matching component configured to match a group offer to the group of users;
a group services component configured to communicate the group offer to the group of users; and
at least one hardware microprocessor configured to execute computer-executable instructions in a memory associated with the clustering engine, offers matching component, and group services component.

2. The system of claim 1, wherein the group services component is associated with a presentation component configured to display the group offers to the group of users.

3. The system of claim 1, wherein the clustering engine creates a subgroup in the group of users, the subgroup having a different interest than the related interest of the group.

4. The system of claim 1, further comprising an offers management service that receives offers from a merchant or advertiser and stores the offers in an offers database, the received offers grouped by the offers matching component.

5. The system of claim 4, wherein the offers management service sends the received offers to the clustering engine.

6. The system of claim 1, wherein the group services component communicates to the group of users the identities of other users of the group that received the group offer and participation status of the other users to the group offer.

7. The system of claim 1, wherein the group services component communicates to a group user the identities of other users of the group that are participating in the offer and a minimum number of user needed to participate and redeem the group offer.

8. The system of claim 1, wherein the group services component communicates to a group user the identities of other users of the group that committed to purchase a group coupon for the group offer.

9. The system of claim 1, wherein the group services component communicates participation status of other group users who received the group offer and enables chat communications between the group users to discuss the group offer.

10. A method, comprising acts of:
identifying a group of users having a related interest;
sending notification of a group coupon to the group of users;
presenting identities of one or more of the users of the group;
enabling communications between users of the notified group of users that receive notification of the group coupon; and
presenting participation status information of the notified users of the group of users as relates to participation in the group coupon and a threshold notification as to status of a group condition.

11. The method of claim 10, further comprising presenting the participation status as relates to participating, undecided, and non-participating.

12. The method of claim 10, further comprising enabling chat communications between users about a specific coupon.

13. The method of claim 10, further comprising creating the group of users from networks of socially-related users.

14. The method of claim 10, further comprising creating a sub-group from the group, the sub-group of users having related interests.

15. The method of claim 10, further comprising matching offers to the group of users as viewable coupons.

16. A computer-readable storage medium comprising computer-executable instructions that when executed by a microprocessor, cause the microprocessor to perform acts of:
identifying a group of users having a related interest;
matching a group offer to the group of users as the group offer relates to the interest;
sending notification of a group offer to the group of users;
enabling communications between the notified group of users that receive notification of the group offer; and
presenting participation status information of the users of the notified group of users as relates to participation in the group offer.

17. The computer-readable storage medium of claim 16, further comprising scheduling joint usage of the group offer.

18. The computer-readable storage medium of claim 16, further comprising identifying clusters of targetable groups of friends according to joint interest and location proximity relative to the group offer location.

19. The computer-readable storage medium of claim 16, further comprising enabling realtime notification to group users related to eligibility of the offer to be redeemed.

20. The computer-readable storage medium of claim 16, further comprising:
offering for bid to vendors a specific group of users; and
receiving from a winning vendor targeted user information and offer parameters from which to identify the group of users and apply the parameters.
